(19) United States
(12) Patent Application Publication
(10) Pub. No.: US 2009/0197453 A1
(43) Pub. Date: Aug. 6, 2009

(54) CONNECTOR FOR CARD

(75) Inventors: Takeshi MURAYAMA, Miyagi-ken (JP); Toru WAGATSUMA, Miyagi-ken (JP); Kazuki SATO, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/343,938

(22) Filed: Dec. 24, 2008

(30) Foreign Application Priority Data
Jan. 31, 2008 (JP) 2008-021112

(51) Int. Cl. H01R 13/62; H01R 13/648

(52) U.S. Cl. 439/326; 439/108

(57) ABSTRACT

A connector for a card includes first contact terminals that come in contact with first outer connection parts of a card to be fitted, and second contact terminals that come in contact with second outer connection parts of the card. Contact parts of the first contact terminals that come in contact with the first outer connection parts, and contact parts of the second contact terminals that come in contact with the second outer connection parts are formed to face directions orthogonal to each other.

### CROSS REFERENCE TO RELATED APPLICATION

The present application claims benefit of Japanese Patent Application No. 2008-021112 filed in the Japanese Patent Office on Jan. 31, 2008, the entire contents of which is incorporated herein by reference.

### BACKGROUND

1. Technical Field

The present invention relates to a connector for a card, and more particularly, to a connector for a card that is suitable for an adapter for a card required to reduce the thickness of a device.

2. Related Art

In the past, there has been proposed a connector where contact terminals come in contact with contact pads formed on inner wall surfaces, which face each other, among inner wall surfaces of a groove formed at an end of an object that is to be fitted and has the shape of a card (for example, see Japanese Unexamined Patent Application Publication No. 2000-243491). According to this connector, it is possible to increase the number of contact terminals and the number of contacts that come in contact with an object to be fitted.

However, in the above-mentioned connector in the related art, the contact terminals come in contact with the contact pads that are formed on the inner wall surfaces of the groove. Accordingly, contact parts of the contact terminals need to be disposed to overlap in an opposite direction. For this reason, the dimension of the contact parts of the contact terminals is increased in the opposite direction. Therefore, there is a problem in that it is difficult to reduce the thickness of the connector.

### SUMMARY

An advantage of some aspects of the invention is to provide a connector for a card that can reduce the thickness of a connector while coping with the increase of the number of contacts.

According to an aspect of the invention, a connector for a card includes first contact terminals that come in contact with first outer connection parts of a card to be fitted, and second contact terminals that come in contact with second outer connection parts of the card. Contact parts of the first contact terminals that come in contact with the first outer connection parts, and contact parts of the second contact terminals that come in contact with the second outer connection parts are formed to face directions orthogonal to each other.

According to the connector for a card, since the contact parts of the first contact terminals and the contact parts of the second contact terminals are formed to face directions orthogonal to each other, a dimension in the thickness direction (a direction where the contact parts of the contact terminals face) does not need to be ensured unlike in the connector in the related art. Therefore, it is possible to reduce the thickness of the connector while coping with the increase of the number of contacts.

In the connector for a card, the first outer connection parts may be formed on one surface of a groove formed at an end of the card, and the second outer connection parts may be formed on the other surfaces thereof that are connected to the one surface. Further, the first and second contact terminals may be provided in the form of a cantilever beam, and free ends including the contact parts may extend in a direction where the card is discharged. In this case, it is possible to dispose the first and second contact terminals so that the first and second contact terminals are received in the groove of the card. As a result, it is possible to reduce a space in which the first and second contact terminals are provided, and to reduce the size of the connector.

In the connector for a card, the plurality of first contact terminals may be arranged in parallel, and the second contact terminals may be provided outside the outermost first contact terminals of the first contact terminals that are arranged in parallel. Since the second contact terminals are provided outside the outermost first contact terminals of the first contact terminals, it is possible to arrange the plurality of the first contact terminals in parallel without limiting the positions of the first contact terminals.

In the connector for a card, the second outer connection parts may form ground parts, and the second contact terminals may form ground terminals. As described above, the ground parts of the card are disposed on the surfaces (for example, vertical surfaces) different from the surface (for example, horizontal surface) on which the first outer connection parts for signal communication are formed. Accordingly, it is possible to dispose the contact terminals in a direction where the contact terminals are not instantaneously separated from the vertical surfaces even though the contact terminals are instantaneously separated from the horizontal surface when a vibration, an impact, or the like is generated in a vertical direction. Therefore, it is possible to improve the stability of ground.

In the connector for a card, the second contact terminals further extend in a direction where the card is discharged, as compared to the first contact terminals. In this case, when the card is fitted to the connector, the second contact terminals for grounding come in contact with the card before the first contact terminals come in contact with the card. Even though the card is charged with static electricity, the static electricity may be discharged to the second contact terminals for grounding. As a result, it is possible to prevent other components, which are connected to the first contact terminals, from being damaged by electrostatic discharge.

According to the aspect of the invention, since the contact parts of the first contact terminals and the contact parts of the second contact terminals are formed to face directions orthogonal to each other, a dimension in the thickness direction (a direction where the contact parts of the contact terminals face) does not need to be ensured unlike in the connector in the related art. Therefore, it is possible to reduce the thickness of the connector while coping with the increase of the number of contacts.

### BRIEF DESCRIPTION OF THE DRAWINGS

FIG. 1 is a perspective view showing the appearances of an adapter to which a connector according to an embodiment of the invention is applied and a card that is fitted to the adapter.

FIG. 2 is a perspective view showing the appearances of the adapter to which the connector is applied and the card that is fitted to the adapter.

FIG. 3A is a top view of the card fitted to the connector according to the embodiment, FIG. 3B is a side view of the card, and FIG. 3C is a bottom view of the card.

FIG. 4A is a front view of the card fitted to the connector according to the embodiment, and FIG. 4B is a perspective view of the card as seen from the lower surface of the card.

FIG. 5A is a perspective view of a peripheral portion of contact terminals of the connector according to the embodiment, and FIG. 5B is a top view of the peripheral portion of the contact terminals of the connector.

FIG. 6 is a front view of the adapter to which the connector according to the embodiment is applied.

### DESCRIPTION OF EXEMPLARY EMBODIMENTS

An embodiment of the invention will be described in detail below with reference to accompanying drawings. Meanwhile, a case where a connector for a card (hereinafter, simply referred to as a “connector”) according to an embodiment of the invention is applied to an adapter for a card (hereinafter, simply referred to as an “adapter”) will be described below. However, an object to which the connector according to the embodiment of the invention is not limited thereto, and may be appropriately changed. For example, the connector according to the embodiment may be applied to a card slot or the like that is mounted on a personal computer (PC) or a PDA.

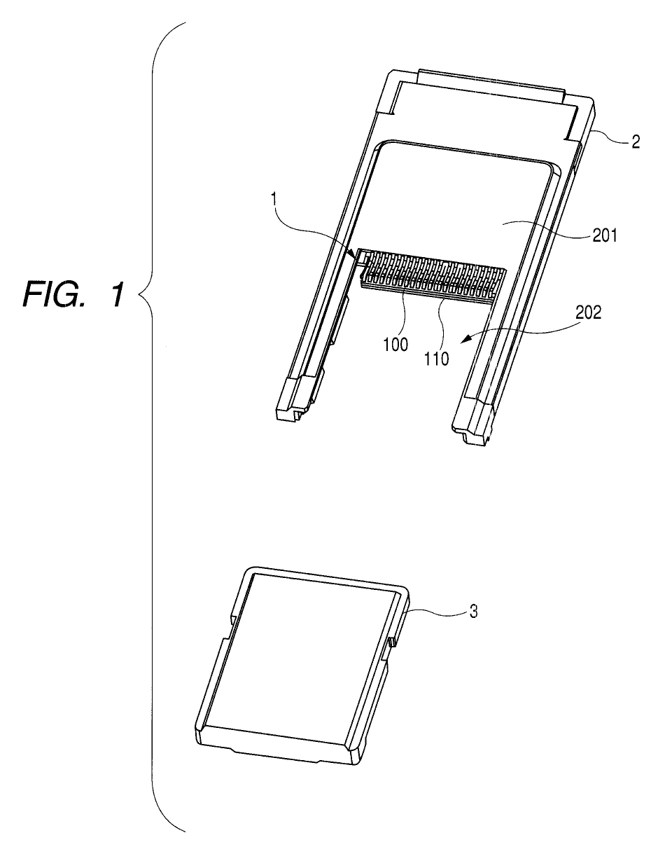

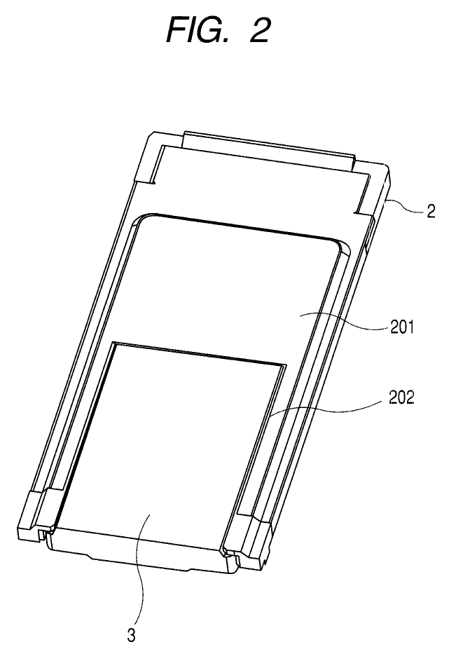

FIGS. 1 and 2 are perspective views showing the appearances of an adapter 2 to which a connector 1 for a card (hereinafter, simply referred to as a “connector”) according to an embodiment of the invention is applied and a memory card (hereinafter, simply referred to as a “card”) 3 that is fitted to the adapter. FIG. 1 shows that the card 3 is not fitted to the connector 1 (adapter 2), and FIG. 2 shows that the card 3 is fitted to the connector. In the following description, the upper side shown in FIGS. 1 and 2 is referred to as the front side of each of the connector 1, the adapter 2, and the card 3, and the lower side shown in FIGS. 1 and 2 is referred to as the rear side of each of the connector 1, the adapter 2, and the card 3.

As shown in FIG. 1, the adapter 2 includes a case 201 that generally has the shape of a flat plate. A slot 202 in which the card 3 is received is formed at a rear portion of the case 201. The connector 1 is disposed at a front portion of the slot 202 in an insertion direction of the card 3. A plurality of terminals, which is connected to first and second contact terminals 101 and 102 of the connector 1 to be described below, is disposed in the case 201, and the ends of the terminals are led to grooves (not shown) that are provided at a front surface of the adapter 2.

The adapter 2 is fitted to a card slot of a PC or the like while the card 3 is fitted to the slot 202 as shown in FIG. 2, and enables a signal to be transmitted and received between the PC and the card 3. Meanwhile, the same structure as a known adapter can be used as the structure of the adapter 2 that does not include the connector 1. Accordingly, the description of the structure of the adapter that does not include the connector will be omitted. In general, the adapter 2 includes a protective member that protects contact terminals of the connector 1, but the protective member is omitted in FIG. 1 for convenience of description.

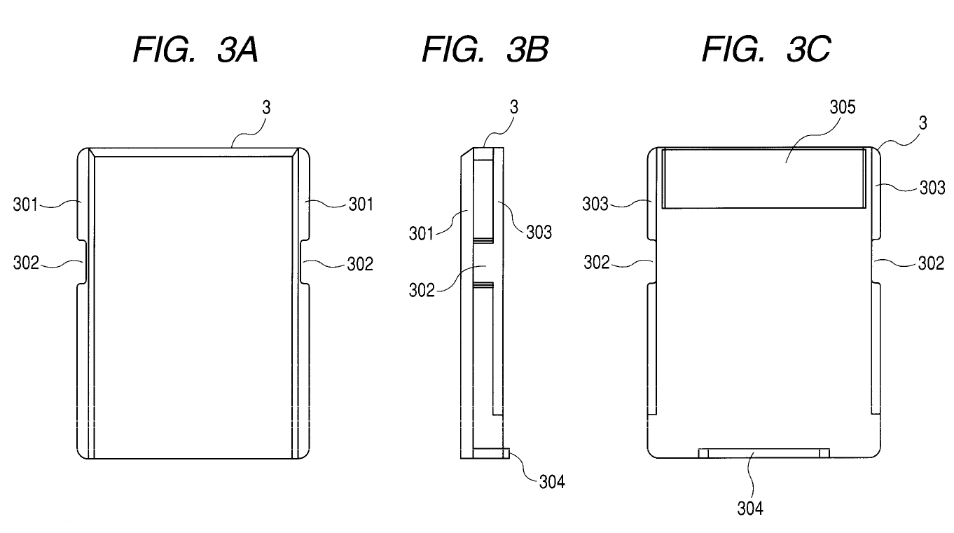

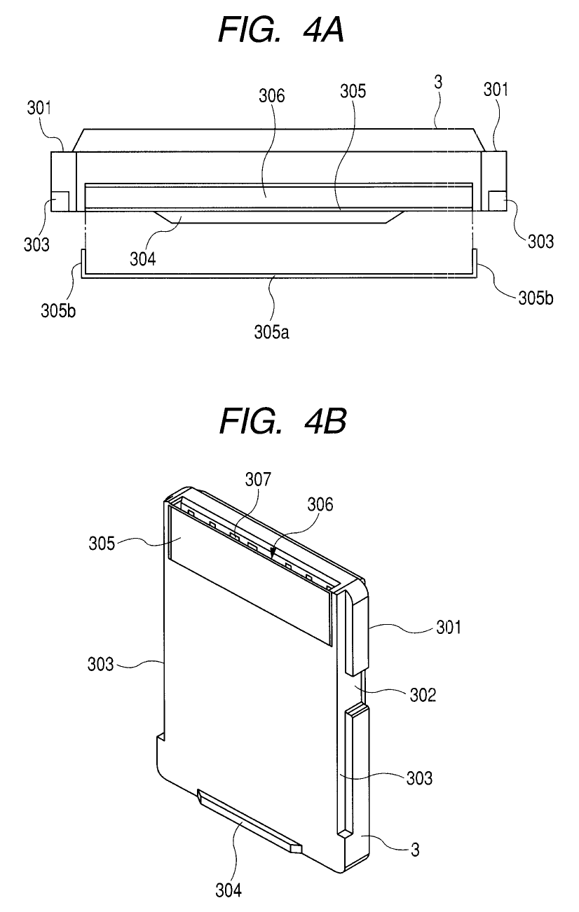

The structure of the card 3 to be fitted to the connector 1 according to this embodiment will be described herein. FIGS. 3 and 4 are views illustrating the structure of the card 3 to be fitted to the connector 1. FIGS. 3A, 3B, and 3C are a top view of the card 3, a side view of the card, and a bottom view of the card, respectively. FIG. 4A is a front view of the card 3, and FIG. 4B is a perspective view of the card 3 as seen from the lower surface of the card. Meanwhile, FIG. 4A shows that a cover 305 to be described below is extracted.

As shown in FIGS. 3A and 3B, stepped portions 301 are formed at upper portions of the side surfaces of the card 3. A pair of (left and right) recesses 302 is formed at the stepped portions 301. Engaging pieces (not shown) provided at the slot 202 of the adapter 2 are engaged with the recesses 302, and are used to prevent the card 3 from being separated from the adapter 2. Meanwhile, as shown in FIGS. 3B and 3C, stepped portions 303 are formed at lower portions of the side surfaces of the card 3. Further, a grip portion 304, which is used to pull out the card 3 from the adapter 2, is formed at the rear end of the card 3.

Further, a recess, which is opened toward the front and lower sides, is formed in the vicinity of the front end on the lower surface of the card 3. As shown in FIG. 3C, a cover 305, which is formed by folding a metal material having conductivity, is fitted to the recess (see FIGS. 4A and 4B). The surface (lower surface) of the cover 305 forms a part of the lower surface of the card 3, prevents contact pads 307, which will be described below, from coming in contact with a user, and serves as an electromagnetic shield of the contact pads 307.

In addition, a groove 306 is formed at the front end of the card 3 as shown in FIGS. 4A and 4B. The groove 306 is formed by fitting the cover 305 to the recess formed in the vicinity of the front end of the card 3. When the card 3 is fitted to the connector 1, the first and second contact terminals 101 and 102 to be described below are received in the groove 306. The upper surface of the groove 306 comes in contact with the first contact terminals 101 to be described below, and is provided with the plurality of contact pads 307 that are used to transmit and receive a signal (see FIG. 4B). Meanwhile, the contact pads 307 form first outer connection parts of the card 3.

Meanwhile, as shown in FIG. 4A, the cover 305, which is fitted to the recess formed in the vicinity of the front end of the card 3, includes a lower surface part 305a that forms a part of the lower surface of the card 3, and side surface parts 305b that extend upward from side ends of the lower surface part 305a. The outer surfaces of the side surface parts 305b are engaged with the inner walls of the recesses, so that the cover is fixed to the card 3. Meanwhile, the inner surfaces of the side surface parts 305b form second outer connection parts that function as ground parts of the card 3.

The card 3 having the above-mentioned structure is fitted to the connector 1 according to this embodiment. As shown in FIG. 1, the connector 1 includes a plurality of contact terminals 100 that is arranged in parallel in a horizontal direction of the connector 1. Meanwhile, a protective plate 110, which is integrated into the case 201 and extends toward the rear side of the connector 1, is disposed near the contact terminals 100. The protective plate 110 is used to prevent the damage of the contact terminals 100 that is caused by the wrong insertion of another card.

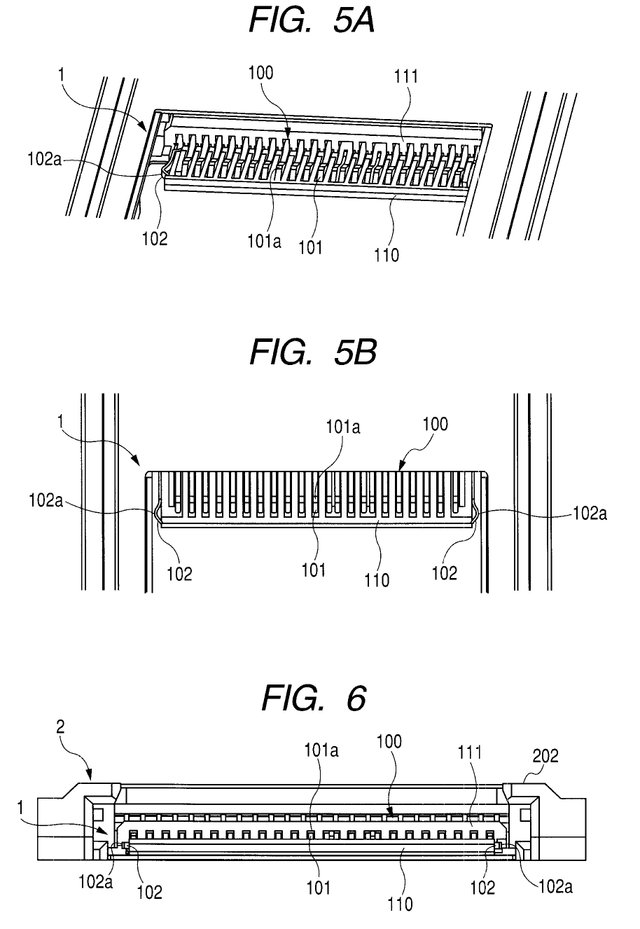

The structure of the contact terminals 100, which are included in the connector 1 according to this embodiment, will be described herein. FIG. 5 is an enlarged view that is used to describe the structure of the contact terminals 100 included in the connector 1. FIGS. 5A and 5B are perspective and top views of a peripheral portion of the contact terminals 100 of the connector 1, respectively. FIG. 6 is a front view of the adapter 2 to which the connector 1 is applied.

As shown in FIG. 5A, the contact terminals 100 are formed of so-called cantilever beam-like contact terminals of which the front ends are held by a holding part 111 integrated into the case 201 and the rear ends form free ends. The contact terminals 100 includes first contact terminals 101 of which the tips of the free ends extend upward, and second contact terminals 102 of which the tips of the free ends extend sideward. The first contact terminals 101 form terminals for signal communication with the card 3, and the second contact terminals 102 form ground terminals of the card 3.

As shown in 5B and 6, each of the first contact terminals 101 includes a contact part 101a, which faces the upper side of the connector 1, in the vicinity of the tip of the free end. Meanwhile, each of the second contact terminals 102 includes a contact part 102a, which faces a direction orthogonal to the contact part of the first contact terminal 101 (toward the side of the connector 1), in the vicinity of the tip of the free end. Since the first and second contact terminals 101 and 102 extend toward the upper side and the side of the connector 1 as described above, a space in which the contact terminals are disposed does not need to be formed below the connector 1.

Further, as shown in FIGS. 5B and 6, the plurality of the first contact terminals 101 is arranged in parallel in the horizontal direction of the connector 1. Furthermore, a pair of second contact terminals 102 is provided outside the outermost first contact terminals of the first contact terminals 101 that are arranged in parallel. Since the second contact terminals 102 are provided as described above, it is possible to arrange the plurality of the first contact terminals 101 in parallel without limiting the positions of the first contact terminals.

In addition, as shown in FIG. 5B, the rear end of each of the second contact terminals 102 further extends toward the rear side (in a direction where the card is discharged) as compared to the rear end of each of the first contact terminals 101. Since the second contact terminals 102, which are used as the ground terminals of the card 3, further extend toward the rear side as compared to the first contact terminals 101, the second contact terminals 102 come in contact with the card 3 before the first contact terminals 101 come in contact with the card.

If the card 3 is fitted to the connector 1 having the above-mentioned structure as shown in FIG. 2, the first contact terminals 101 are inserted into the groove 306 of the card 3 and come in contact with the contact pads 307. Since the first contact terminals 101 form the terminals for signal communication as described above, a PC or the like to which the connector 1 (adapter 2) is fitted can transmit and receive a signal to and from the card 3.

Meanwhile, as the card 3 is fitted to the connector, the second contact terminals 102 are inserted into the groove 306 of the card 3 and come in contact with the inner surfaces of the side surface parts 305b of the over 305 of the card 3. As described above, the second contact terminals 102 form the ground terminals. For this reason, even when the card 3 is charged with static electricity, the static electricity is discharged to the second contact terminals 102. Therefore, it is possible to prevent other components, which are connected to the first contact terminals 101, from being damaged by electrostatic discharge.

In particular, the rear ends of the second contact terminals 102 further extend toward the rear side as compared to the first contact terminals 101. Accordingly, when the card 3 is fitted to the connector 1, the second contact terminals 102 come in contact with the card 3 before the first contact terminals 101 come in contact with the card. As a result, it is possible to reliably prevent other components, which are connected to the first contact terminals 101, from being damaged by electrostatic discharge.

According to the connector 1 of this embodiment, since the contact parts 101a of the first contact terminals 101 and the contact parts 102a of the second contact terminals 102 are formed to face directions orthogonal to each other, a dimension in the thickness direction (a direction where the contact parts of the contact terminals face) does not need to be ensured unlike in the connector in the related art. Therefore, it is possible to reduce the thickness of the connector 1 while coping with the increase of the number of contacts.

Further, in the connector 1 according to this embodiment, the first and second contact terminals 101 and 102 are provided in the form of a cantilever beam, and the free ends of the contact terminals including the contact parts 101a and 102a extend toward the rear side (in a direction where the card is discharged). Accordingly, it is possible to dispose the first and second contact terminals 101 and 102 so that the first and second contact terminals are received in the groove 306 of the card 3. As a result, it is possible to reduce a space in which the first and second contact terminals 101 and 102 are provided, and to reduce the size of the connector 1.

Furthermore, in the connector 1 according to this embodiment, the ground parts of the card 3 are provided on the side surface parts 305b of the cover 305 that are orthogonal to the surface on which the contact pads 307 are formed (herein, a horizontal surface). Accordingly, when vibration, an impact, or the like is generated in a vertical direction, the second contact terminals 102 may not be instantaneously separated from the vertical surfaces even though the first contact terminals 101 are instantaneously separated from the horizontal surface. Therefore, it is possible to improve the stability of ground.

Meanwhile, the invention is not limited to the above-mentioned embodiment, and may have various modifications. As for the above-mentioned embodiment, the size or shape shown in accompanying drawings is not limited and may be appropriately modified within a range where advantages of the invention are obtained. In addition, the invention may have various modifications without departing from the scope and spirit of the present invention.

For example, the first and second contact terminals 101 and 102 have been provided in the form of a cantilever beam in the above-mentioned embodiment, but the structure of the first and second contact terminals 101 and 102 is not limited thereto and may be appropriately modified. In particular, as long as the contact parts 101a and 102a of the first and second contact terminals are formed to face directions orthogonal to each other, any structure may be employed.

It should be understood by those skilled in the art that various modifications, combinations, sub-combinations and alterations may occur depending on design requirements and other factors insofar as they are within the scope of the appended claims of the equivalents thereof.

What is claimed is:

1. A connector for a card comprising:
first contact terminals that come in contact with first outer connection parts of a card to be fitted; and
second contact terminals that come in contact with second outer connection parts of the card,
wherein contact parts of the first contact terminals that come in contact with the first outer connection parts, and contact parts of the second contact terminals that come in contact with the second outer connection parts are formed to face directions orthogonal to each other.

2. The connector for a card according to claim 1,
wherein the first outer connection parts are formed on one surface of a groove formed at an end of the card, and the second outer connection parts are formed on the other surfaces thereof that are connected to the one surface, and
the first and second contact terminals are provided in the form of a cantilever beam, and free ends including the contact parts extend in a direction where the card is discharged.

3. The connector for a card according to claim 1,
wherein the plurality of first contact terminals is arranged in parallel, and
the second contact terminals are provided outside the outermost first contact terminals of the first contact terminals that are arranged in parallel.

4. The connector for a card according to claim 2,
wherein the plurality of first contact terminals is arranged in parallel, and
the second contact terminals are provided outside the outermost first contact terminals of the first contact terminals that are arranged in parallel.

5. The connector for a card according to claim 1,
wherein the second outer connection parts form ground parts, and the second contact terminals form ground terminals.

6. The connector for a card according to claim 5,
wherein the second contact terminals further extend in a direction where the card is discharged, as compared to the first contact terminals.
